(19) United States
(12) Patent Application Publication
(10) Pub. No.: US 2015/0067007 A1
(43) Pub. Date: Mar. 5, 2015

(54) ELECTRONIC DEVICE, METHOD FOR RECOGNIZING EXTERNAL STORAGE DEVICE, COMPUTER PROGRAM PRODUCT

(71) Applicant: KABUSHIKI KAISHA TOSHIBA, Tokyo (JP)

(72) Inventor: Tomoyuki KOKUBUN, Ome-shi (JP)

(21) Appl. No.: 14/451,093

(22) Filed: Aug. 4, 2014

Related U.S. Application Data
(60) Provisional application No. 61/870,927, filed on Aug. 28, 2013.

(51) Int. Cl. G06F 17/30; G06F 3/06

(52) U.S. Cl. CPC G06F 17/30115; G06F 17/30221; G06F 3/0604; G06F 3/0643; G06F 3/0673
USPC 707/829

(57) ABSTRACT

According to one embodiment, an electronic device has an interface, storage and a controller. The interface is configured to connect with an external storage device. The storage is configured to store data. The controller is configured to determine whether information for identifying a folder name is stored in the external storage device when the external storage device is connected to the interface, and to recognize the external storage device as a folder having the folder name corresponding to the information when the information is stored in the external storage device.

### CROSS-REFERENCE TO RELATED APPLICATIONS

This application claims the benefit of U.S. Provisional Application No. 61/870,927, filed Aug. 28, 2013.

### FIELD

Embodiments described herein relate generally to an electronic device, a method for recognizing external storage device, and a computer program product.

### BACKGROUND

Conventionally, there has been known an electronic device connectable with external storage devices.

It is convenient that external storage devices can be treated as folders having predetermined folder names in such a conventional electronic device when the external storage devices are connected to the electronic device.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram illustrating the entire structure of a personal computer (PC) and a USB flash drive (USB memory) according to an embodiment;

FIG. 2 is an exemplary block diagram illustrating an internal structure of the PC and the USB memory in the embodiment;

FIG. 3 is an exemplary diagram illustrating a folder name input receiving screen displayed on a display module of the PC in the embodiment;

FIG. 4 is an exemplary diagram illustrating an image displayed on the display module before the USB memory is recognized as a folder in the PC in the embodiment;

FIG. 5 is an exemplary diagram illustrating an image displayed on the display module after the USB memory is recognized as a folder in the PC in the embodiment;

FIG. 6 is an exemplary diagram illustrating an image displayed on the display module in a case in which a user has performed an operation for opening a folder corresponding to the USB memory when the image illustrated in FIG. 4 is displayed on the display module of the PC in the embodiment;

FIG. 7 is an exemplary flow chart illustrating a processing flow executed by a controller of the PC after the USB memory is connected to the PC in the embodiment; and

FIG. 8 is an exemplary flow chart illustrating a processing flow corresponding to an assignment program executed by the controller of the PC in the embodiment.

### DETAILED DESCRIPTION

In general, according to one embodiment, an electronic device comprises an interface, storage and a controller. The interface is configured to connect with an external storage device. The storage is configured to store data. The controller is configured to determine whether information for identifying a folder name is stored in the external storage device when the external storage device is connected to the interface, and to recognize the external storage device as a folder having the folder name corresponding to the information when the information is stored in the external storage device.

Hereinafter, the embodiment will be specifically described with reference to the drawings.

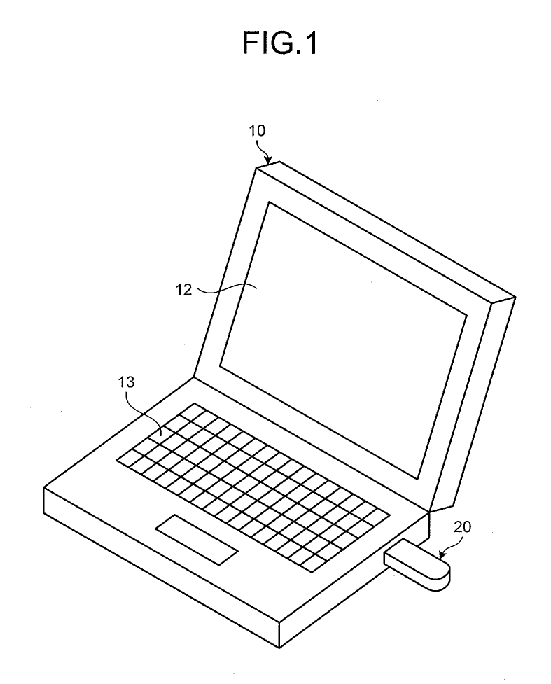

First, with reference to FIG. 1 to FIG. 6, the structure of a personal computer (PC) 10 according to the embodiment will be described. The PC 10 is an example of an “electronic device (information processing device)”.

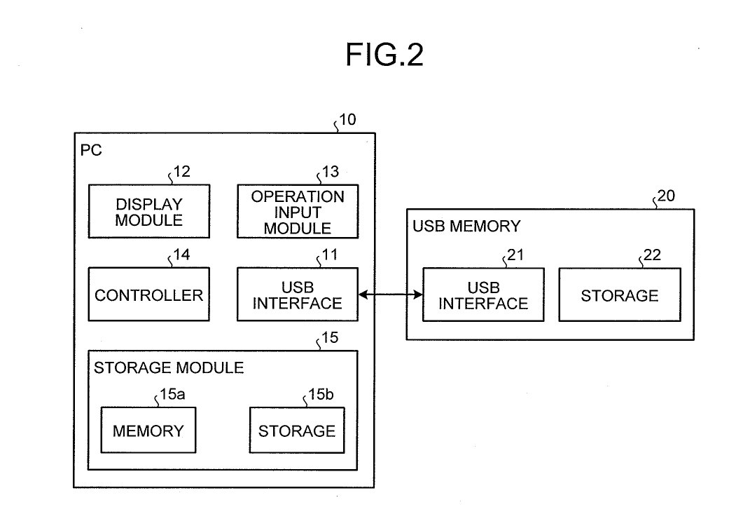

As illustrated in FIG. 1, the PC 10 is configured to be connectable with a USB flash drive (USB memory) 20 as an external storage device. As illustrated in FIG. 2, the PC 10 comprises a USB interface 11, a display module 12, an operation input module 13, a controller 14, and a storage module 15. The storage module 15 comprises a memory 15a and storage 15b.

The USB interface 11 is an interface for connecting devices conforming to a universal serial bus (USB) standard. Examples of the devices conforming to the USB standard include the USB memory 20. The USB memory 20 comprises a USB interface 21 configured to be connectable to the USB interface 11 and storage 22 comprising a flash memory and the like configured to be capable of storing data therein.

The display module 12 is configured to be capable of displaying an image. The operation input module 13 is configured to receive various operation inputs from a user to the PC 10. Examples of the operation input modules 13 include a keyboard for inputting characters.

The controller 14 is configured to control each component of the PC 10. The storage module 15 is configured to be capable of storing various computer programs executed by the controller 14 (for example, an assignment program to be described later) and various pieces of data used when the various computer programs are executed.

Specifically, the memory 15a of the storage module 15 comprises a read only memory (ROM) or a random access memory (RAM) as a main storage device. The storage 15b of the storage module 15 comprises a hard disk drive (HDD) and a solid state drive (SSD) as auxiliary storage devices. The storage 15b is configured to be capable of storing data therein in units of folders (directories).

In the embodiment, the controller 14 is configured to be capable of controlling to recognize (assign) the USB memory 20 as a folder in the PC 10 (storage 15b) when the USB memory 20 is connected to the USB interface 11. Specifically, in order to enable access from the PC 10 to data in the USB memory 20 connected to the USB interface 11, the controller 14 is configured to be capable of controlling to display, on the display module 12, a folder that functions as an alias (shortcut) for accessing a root folder of the USB memory 20, as a folder in the storage 15b.

Specifically, the controller 14 is configured to determine whether folder name identification information to be described later is stored in the storage 22 of the USB memory 20 when the USB memory 20 is connected to the USB interface 11. The controller 14 is configured to control, if the folder name identification information is stored in the storage 22, to read the folder name identification information from the storage 22, and to recognize (assign) the USB memory 20 as a folder in the storage 15b having a folder name corresponding to the read folder name identification information.

The folder name identification information is information including the folder name of a folder displayed on the display module 12 as an alias for accessing the root folder of the USB memory 20, a flag indicating whether the USB memory 20 supports a function for assigning a folder name as described above, and the like. The folder name identification information is configured to be stored in a predetermined region in the storage 22 of the USB memory 20. For example, the folder name identification information is configured to be stored in a hidden region such as a master boot record (MBR) in the storage 22, or be stored as a system file in a region in which normal data is stored, in the storage 22.

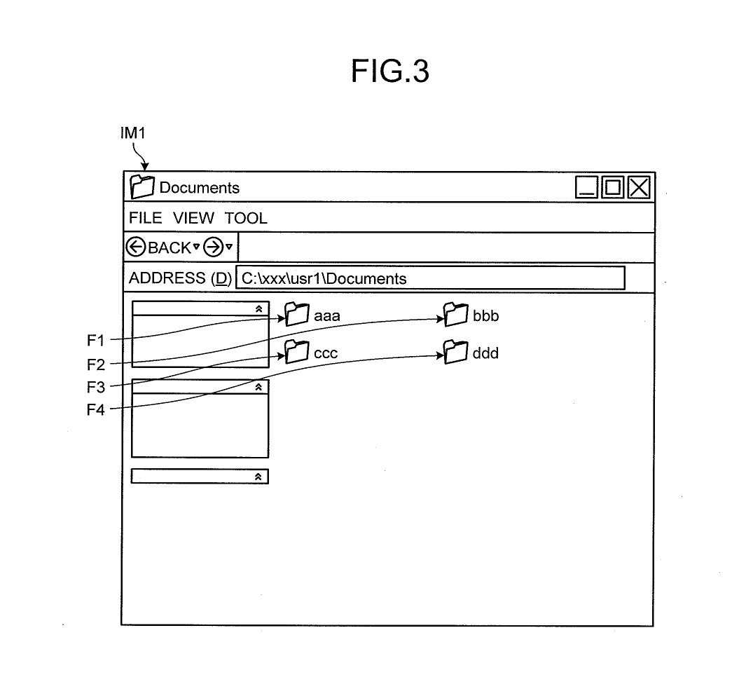

With reference to FIG. 3 to FIG. 5, an example describes how the alias for accessing the USB memory 20 is displayed on the display module 12 of the PC 10 when the PC 10 is connected with the USB memory 20 in which the folder name identification information is stored in advance. Hereinafter, described is an example in which the folder name identification information corresponding to a folder name of “My_USB_Stick” is stored in the USB memory 20 in advance.

FIG. 3 is an exemplary diagram illustrating a folder structure of a folder named “Documents” in the PC 10 (storage 15b) before the USB memory 20 is connected to the PC 10. A screen IM1 illustrated in FIG. 3 is displayed on the display module 12 of the PC 10. As illustrated in FIG. 3, the folder named “Documents” has an address (path) of “C:\xxx\usr1\Documents”. Also as illustrated in FIG. 3, the folder named “Documents” includes a folder F1 having a folder name of “aaa”, a folder F2 having a folder name of “bbb”, a folder F3 having a folder name of “ccc”, and a folder F4 having a folder name of “ddd”.

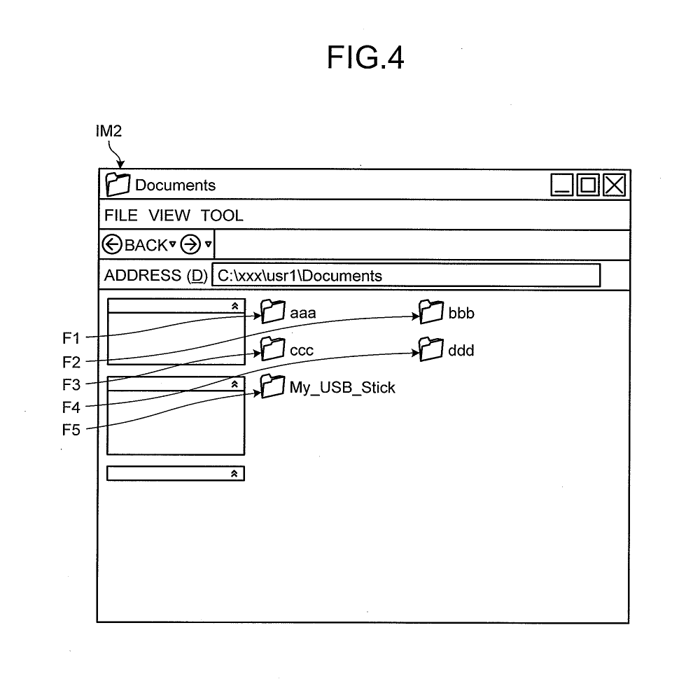

FIG. 4 is an exemplary diagram illustrating a folder structure of the folder named “Documents” after the USB memory 20 is connected to the PC 10. Similarly to the screen IM1 (refer to FIG. 3), a screen IM2 illustrated in FIG. 4 is displayed on the display module 12 of the PC 10. As illustrated in FIG. 4, after the USB memory 20 is connected to the PC 10, there is a folder F5 named “My_USB_Stick” that functions as an alias for accessing the root folder of the USB memory 20 in the folder named “Documents”, in addition to the folders F1 to F4.

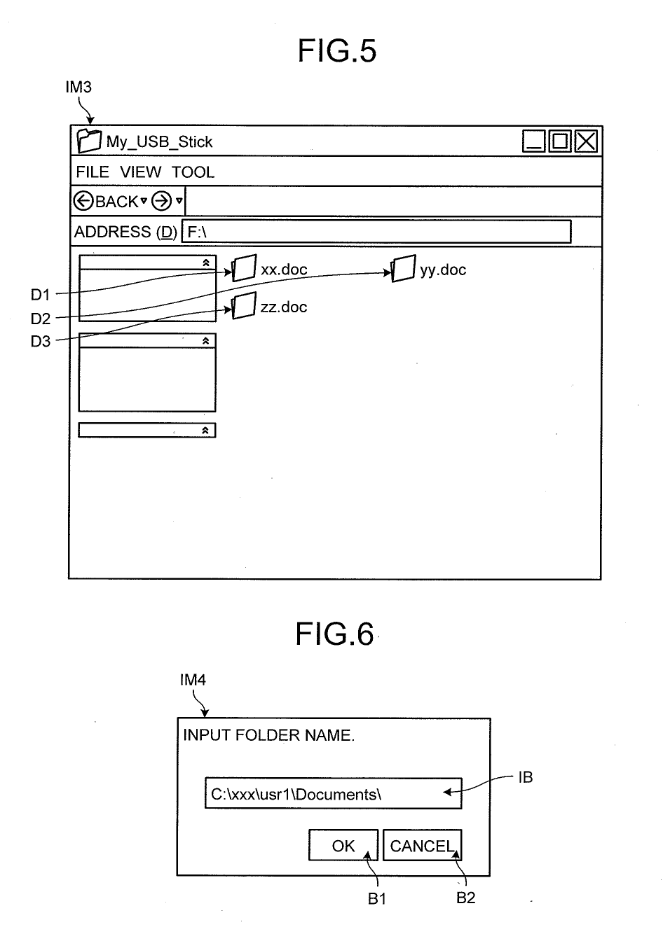

Accordingly, an operation for opening the folder F5 named “My_USB_Stick” on the screen IM2 (refer to FIG. 4) allows a screen IM3 (refer to FIG. 5) corresponding to the root folder of the USB memory 20 to be displayed on the display module 12 of the PC 10. FIG. 5 is an exemplary diagram illustrating a folder structure of the root folder of the USB memory 20. As illustrated in FIG. 5, the root folder of the USB memory 20 includes a document file D1 having a file name of “xx.doc”, a document file D2 having a file name of “yy.doc”, and a document file D3 having a file name of “zz.doc”. The root folder of the USB memory 20 has an address of “F:\”. A character of “F” in the address is a drive letter assigned by the OS of the PC 10 when the USB memory 20 is connected to the PC 10. In general, a drive letter is assigned so as to avoid duplication among devices connected to the PC 10.

In the embodiment, when the PC 10 (storage 15b) already has a folder having the folder name corresponding to the folder name identification information read from the USB memory 20, the controller 14 changes the folder name of the folder that functions as the alias of the USB memory 20 so as to avoid duplication of the folder name. For example, a method for changing the folder name as described above is exemplified by a method in which the controller 14 adds some character string such as a numeral to the end of the folder name corresponding to the folder name identification information read from the USB memory 20.

In the embodiment, the controller 14 is configured to control to display a folder name input receiving screen IM4 (refer to FIG. 6) for receiving an input of a folder name from a user on the display module 12 when the folder name identification information is not stored in the USB memory 20 (storage 22). The controller 14 is configured to control, when the user inputs a folder name, to recognize the USB memory 20 in which the folder name identification information is not stored as a folder in the PC 10 (storage 15b) having the folder name input by the user. The controller 14 is configured to control to store the folder name identification information corresponding to the folder name input by the user in the USB memory 20 (storage 22).

The folder name input receiving screen IM4 illustrated in FIG. 6 displays a message of “input folder name”, an input box IB, an “OK” button B1, and a “CANCEL” button B2, byway of example. The user may assign a desired folder name to the USB memory 20 by performing operation of inputting the desired folder name in the input box IB and pushing the “OK” button B1 (operation using the operation input module 13).

In the embodiment, as illustrated in FIG. 6, it is configured that the input box IB of the folder name input receiving screen IM4 already displays an address (“C:\xxx\usr1\Documents\”) of a folder in the storage 15b in which the alias of the USB memory 20 is to be created. Consequently, an input operation load of the user can be reduced because it is unnecessary to input the whole address each time assigning a folder name to the USB memory 20.

In the embodiment, the controller 14 is configured to control to display the folder name input receiving screen IM4 on the display module 12 also when the user changes the folder name identification information previously stored in the USB memory 20 (storage 22). This allows the user to change the folder name to be assigned to the USB memory 20 by performing an operation of inputting a desired folder name in the input box IB (refer to FIG. 6) and pushing the “OK” button B1 (refer to FIG. 6).

In the embodiment, a computer program (hereinafter, referred to as an assignment program) for performing the folder name assigning processing as described above (processing for recognizing the USB memory 20 as a folder in the PC 10) is configured to be stored in at least one of the storage module 15 such as the memory 15a or the storage 15b in the PC 10 and the storage 22 of the USB memory 20. The controller 14 is configured to control to read the assignment program from the storage 15b and to execute the assignment program read from the storage 15b when the assignment program is stored in the storage 15b of the PC 10, for example. Alternatively, the controller 14 is configured to control to read the assignment program from the storage 22 and to execute the assignment program read from the storage 22 when the assignment program is stored not in the storage 15b of the PC 10 but in the storage 22 of the USB memory 20, for example.

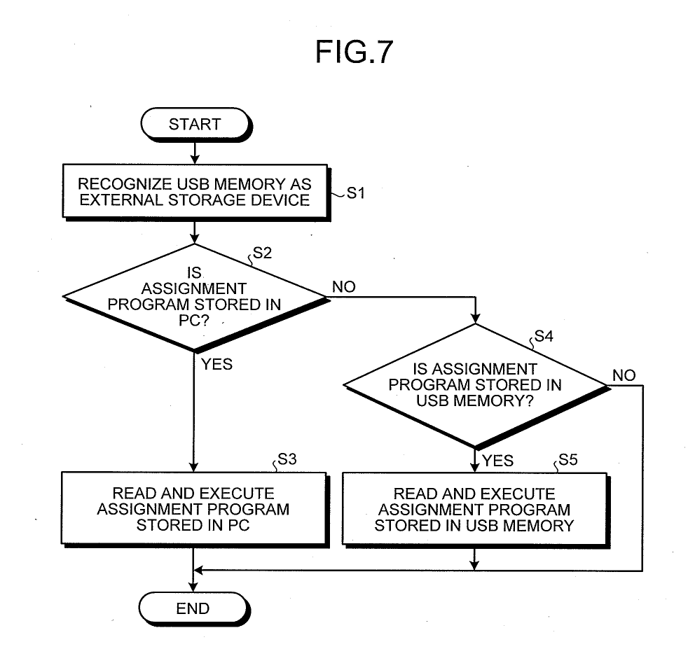

Next, with reference to FIG. 7, described is a processing flow executed by the controller 14 when the USB memory 20 is connected to the PC 10 according to the embodiment.

In this processing flow, as illustrated in FIG. 7, processing of recognizing the USB memory 20 as an external storage device is executed at S1. Specifically, the OS of the PC 10 performs processing of assigning an appropriate drive letter (for example, a drive letter that is not assigned to any device connected to the PC 10) to the USB memory 20. The processing then proceeds to S2.

Next, at S2, processing, the processing being that of determining whether the assignment program for recognizing (assigning) the USB memory 20 as a folder in the PC 10 is stored in the storage module 15 (the memory 15a or the storage 15b) of the PC 10, is executed.

If it is determined that the assignment program is stored in the PC 10 at S2, the processing proceeds to S3. At S3, processing of reading and executing the assignment program stored in the PC 10 is executed. Then the processing ends.

If it is determined that the assignment program is not stored in the PC 10 at S2, the processing proceeds to S4. At S4, processing of determining whether the assignment program is stored in the USB memory 20 (storage 22) is executed.

If it is determined that the assignment program is stored in the USB memory 20 at S4, the processing proceeds to S5. At S5, processing of reading and executing the assignment program stored in the USB memory 20 is executed. Then the processing ends.

If it is determined that the assignment program is not stored in the USB memory 20 at S4, the processing ends without processing of executing the assignment program as in S2 or S5.

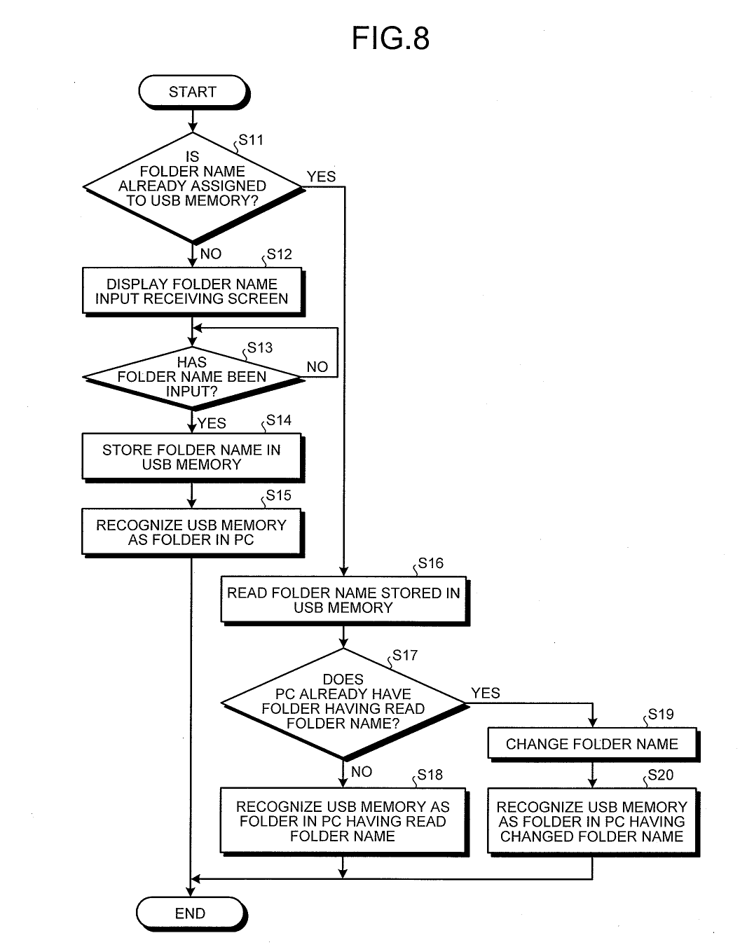

Next, with reference to FIG. 8, described is a processing flow corresponding to the assignment program executed by the controller 14 of the PC 10 according to the embodiment.

As illustrated in FIG. 8, in this processing flow, firstly processing of determining whether a folder name is already assigned to the USB memory 20 connected to the PC 10 is executed at S11. Specifically, processing of determining whether the data corresponding to the folder name is stored in a predetermined region in the storage 22 of the USB memory 20 is executed.

If it is determined that the folder name is not assigned to the USB memory 20 at S11, the processing proceeds to S12. At S12, processing of displaying the folder name input receiving screen IM4 (refer to FIG. 6) on the display module 12 of the PC 10 is executed, and then the processing proceeds to S13.

At S13, processing of determining whether a folder name has been input to the folder name input receiving screen IM4 (refer to FIG. 6) is executed. Specifically, processing, the processing being that of determining whether a folder name (for example, “My_USB_Stick”) has been input in the input box IB of the folder name input receiving screen IM4 and the “OK” button B1 is pushed based on the operation of the operation input module 13 by the user of the PC 10, is executed.

The processing at S13 is repeated until it is determined that a folder name has been input to the folder name input receiving screen IM4 (refer to FIG. 6). If it is determined that a folder name has been input to the folder name input receiving screen IM4 at S13, the processing proceeds to S14.

At S14, processing of storing the data corresponding to the folder name input at S13 to a predetermined region in the storage 22 of the USB memory 20 is executed. Then the processing proceeds to S15.

At S15, processing of recognizing (assigning) the USB memory 20 as a folder in the PC 10 is executed. Accordingly, a folder having the folder name input at S13 (for example, “My_USB_Stick”) is displayed in a predetermined folder in the PC 10 (for example, the folder named “Documents” illustrated in FIG. 3 and FIG. 4) as the alias for accessing the USB memory 20. Then the processing ends.

If it is determined that the folder name is already assigned to the USB memory 20 at S11, the processing proceeds to S16. At S16, processing of reading the data corresponding to the folder name stored in the predetermined region in the storage 22 of the USB memory 20 is executed. Then the process proceeds to S17.

At S17, processing of determining whether does the PC 10 already have a folder having the folder name read from the storage 22 through the processing at S16 is executed.

If it is determined that the PC 10 does not have the folder having the folder name read from the storage 22 at S17, the processing proceeds to S18. At S18, processing of recognizing the USB memory 20 as a folder in the PC 10 having the folder name read from the storage 22 is executed. Then the processing ends.

If it is determined that the PC 10 already has the folder having the folder name read from the storage 22 at S17, the processing proceeds to S19. At S19, processing of changing the folder name read from the storage 22 to a folder name that does not exist in the PC 10 (for example, processing of adding some character string such as a numeral to the end of the folder name) is executed. Then the processing proceeds to S20. At S20, processing of recognizing the USB memory 20 as a folder in the PC 10 having the changed folder name is executed. Then the processing ends.

As described above, in the embodiment, the controller 14 is configured to control to determine whether the folder name identification information is stored in the USB memory 20 when the USB memory 20 is connected to the USB interface 11, and to recognize the USB memory 20 as a folder in the PC 10 (storage 15b) having the folder name corresponding to the folder name identification information when the folder name identification information is stored in the USB memory 20. Accordingly, for example, when connected to the PC 10, the USB memory 20 can be treated as a folder having a predetermined folder name in the PC 10. This improves, for example, convenience for the user in accessing the USB memory 20 through the PC 10.

That is, in the related art, in a case in which one external storage device is connected to a plurality of electronic devices, the external storage device is usually assigned with drive letters different among the electronic devices. Therefore, addresses for accessing the external storage device are often different among the electronic devices. In such related art, the convenience for the user may be impaired in accessing the external storage device through the electronic device. In contrast, in the embodiment, even when the USB memory 20 is connected to a plurality of electronic devices including the PC 10, the USB memory 20 is assigned with a folder name common among the electronic devices based on the folder name identification information stored in the USB memory 20, thereby the convenience for the user in accessing the USB memory 20 can be improved.

As described above, in the embodiment, the controller 14 is configured to control to recognize the USB memory 20 as a folder in the PC 10 (storage 15b) having a folder name input by the user when the folder name identification information is not stored in the USB memory 20. Accordingly, by way of example, even when the folder name identification information is not stored in the USB memory 20, the USB memory 20 can be accessed with the folder name input by the user. This further improves the convenience for the user in accessing the USB memory 20 through the PC 10.

As described above, in the embodiment, the controller 14 is configured to control to display the folder name input receiving screen IM4 for receiving the input of the folder name from the user on the display module 12 when the folder name identification information is not stored in the USB memory 20. Accordingly, byway of example, a folder name to be assigned to the USB memory 20 can be easily set by inputting a desired folder name through the folder name input receiving screen IM4.

As described above, in the embodiment, the controller 14 is configured to control to store the folder name identification information corresponding to the folder name input by the user in the USB memory 20 when the folder name identification information is not stored in the USB memory 20. Accordingly, by way of example, the folder name identification information corresponding to the folder name is stored in the USB memory 20 by inputting the folder name only once, thereby the convenience for the user can be improved because it is not necessary to input the folder name multiple times.

As described above, in the embodiment, the controller 14 is configured to read the assignment program from the storage 15b and execute the assignment program when the storage 15b stores therein the assignment program. The assignment program is a computer program for recognizing the USB memory 20 as a folder in the PC 10 (storage 15b). The controller 14 is configured to read the assignment program from the USB memory 20 and execute the assignment program when the assignment program is stored not in the storage 15b but in the USB memory 20. Accordingly, the assignment program may be reliably executed by storing the assignment program in at least one of the PC 10 and the USB memory 20.

As described above, in the embodiment, the PC 10 has a hardware structure utilizing a normal computer, and a computer program executed by the controller 14 is stored in the storage module 15 such as the memory 15a or the storage 15b (or the storage 22 of the USB memory 20). The computer program is provided as an installable file or an executable file, and as a computer program product having a computer-readable recording medium such as a CD-ROM, a flexible disk (FD), a CD-R, and a digital versatile disk (DVD). The computer program may be configured to be stored on a computer connected to a network such as the Internet and to be provided or distributed via the network. The computer program may also be configured to be provided in a state of being incorporated in a ROM and the like in advance.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An electronic device comprising:
an interface configured to connect with an external storage device;
storage configured to store data; and
a controller configured to determine whether information for identifying a folder name is stored in the external storage device when the external storage device is connected to the interface, and to recognize the external storage device as a folder having the folder name corresponding to the information when the information is stored in the external storage device.

2. The electronic device of claim 1, wherein the controller is configured to recognize the external storage device as a first folder having a first folder name input by a user when the information is not stored in the external storage device.

3. The electronic device of claim 2, wherein the controller is configured to display a screen on a display module when the information is not stored in the external storage device, the screen being configured to receive the first folder name from the user.

4. The electronic device of claim 2, wherein the controller is configured to store the first information corresponding to the first folder name input by the user in the external storage device when the information is not stored in the external storage device.

5. The electronic device of claim 1, wherein the controller is configured to read a first computer program from the storage and execute the first computer program, and to read a computer program from the external storage device and execute the computer program when the computer program is stored not in the storage but in the external storage device, the computer program being configured to recognize the external storage device as the folder in the storage.

6. A method for recognizing an external storage device, the method comprising:
determining whether information for identifying a folder name is stored in the external storage device when the external storage device is connected to an electronic device comprising storage configured to store data; and
recognizing the external storage device as a folder having a folder name corresponding to the information when the information is stored in the external storage device.

7. A computer program product having a non-transitory computer readable medium including programmed instructions, wherein the instructions, when executed by a computer, cause the computer to perform:
determining whether information for identifying a folder name is stored in an external storage device when the external storage device is connected to an electronic device comprising storage configured to store data; and
recognizing the external storage device as a folder having a folder name corresponding to the information when the information is stored in the external storage device.
